(19) United States
(12) Patent Application Publication
(10) Pub. No.: US 2007/0146153 A1
(43) Pub. Date: Jun. 28, 2007

(54) Motion sensing talking technology

(76) Inventors: Bernard Blane LaFleur, Pulaski, VA (US); Tamala Manning LaFleur, Pulaski, VA (US)

Correspondence Address: Bernard Blane LaFleur, 539 Randolph Avenue, Pulaski, VA, 24301, US

(21) Appl. No.: 11/646,914

(22) Filed: Dec. 28, 2006

Related U.S. Application Data
(60) Provisional application No. 60/754,353, filed on Dec. 28, 2005.
(60) Provisional application No. 60/763,698, filed on Jan. 31, 2006.

(51) Int. Cl. G08B 21/00; G08B 13/14

(52) U.S. Cl. 340/686.1; 340/568.1

(57) ABSTRACT

An apparatus to monitor the natural at rest status of an item and alerting system whereupon movement of the item is detected when the item is otherwise disturbed from its natural at rest position and contains a base member of a shape to receive the electronics assembly, a circuit board, a motion sensor, a sound chip, a microphone, a speaker, switches, a power source, non-volatile memory, a cover plate secured to the base member and securing the electronics assembly, adhesive tape, and an ornamental member attached to the apparatus so as to be exchanged in favor of another ornamental member.

### CROSS REFERENCE TO RELATED APPLICATIONS

This application is based on provisional application Ser. No. 60/754,353, filed on Dec. 28, 2005 and provisional application Ser. No. 60/763,698, filed on Jan. 31, 2006.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of motion sensing monitoring and more specifically to an apparatus to monitor the natural at rest status of an item and alerting system whereupon movement of the item is detected or the item is otherwise disturbed from its natural at rest position.

This apparatus is designed to monitor the natural at rest status of the item whereupon this apparatus is incorporated within or upon. When the item is moved or otherwise disturbed from its natural at rest position the motion sensor will activate the the electronics contained therein to play back the aural message, sound file and optionally the light emitting device which could assist in identifying which item has been disrupted or provide illumination for other uses.

When an item equipped with this apparatus is disrupted it will alert, startle and amuse the nearby person<s > with the output of an aural message, music, singing or sound effects. There can be an optional recording capability to capture the utterance of children or other in person recordings which are then stored in non-volatile memory for play back upon motion activation.

This apparatus is designed to:monitor the natural at rest status; startle and amuse nearby person<s > when activated; play an aural message or sound file when activated; display light emitting device when activated; be stealthy in design; allow for in person voice or sound recording; be easily used by anyone; and be cost efficient to manufacture.

There are no direct similar devices. The technology has been well documented on the ability to have miniature electronics provide sound output as evidenced in the many variations of Talking Greeting Cards, Talking Gift Tags or other voice recording/playback products. These products however require a specific interaction from a user to either: open the item, press a button, slide a switch or such actions to energize or operate said devices greatly limiting or omitting monitoring status of the item.

Many products have incorporated proximity or light sensors into their devices attempting to solve or otherwise address the the monitoring status and required specific interaction requirements to energize or activate these devices. These type devices often have false readings due to the limitations of the proximity or light sensors. Movement of the device is not being monitored.

### BRIEF SUMMARY OF THE INVENTION

The primary object of the invention is To provide a system for monitoring the safe repose or the natural at rest status of an item.

Another object of the invention is To startle and amuse nearby person<s> when activated.

Another object of the invention is play an aural message or sound file when activated.

A further object of the invention is illuminate the device when activated.

Yet another object of the invention is To be stealthy in appearance.

Still yet another object of the invention is allow for in person voice or sound recording.

Another object of the invention is be easily used by anyone.

Another object of the invention is be cost efficient to manufacture.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an apparatus to monitor the natural at rest status of an item and alerting system whereupon movement of the item is detected when the item is otherwise disturbed from its natural at rest position comprising: a base member of a shape to receive the electronics assembly, a circuit board, a motion sensor, a sound chip, a microphone, a speaker, switches, connection means for connecting to a power source, non-volatile memory means, a cover plate means secured to said base member and securing said electronics assembly, adhesive tape, and an ornamental member attached to said apparatus so as to be exchanged in favor of another ornamental member.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a top view of the invention.

FIG. 3 is a bottom view of the invention.

FIG. 4 is a perspective view of the invention.

FIG. 5 is a schematic block diagram of the data processing system.

FIG. 6 is a view of ornamental adornments incorporating the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

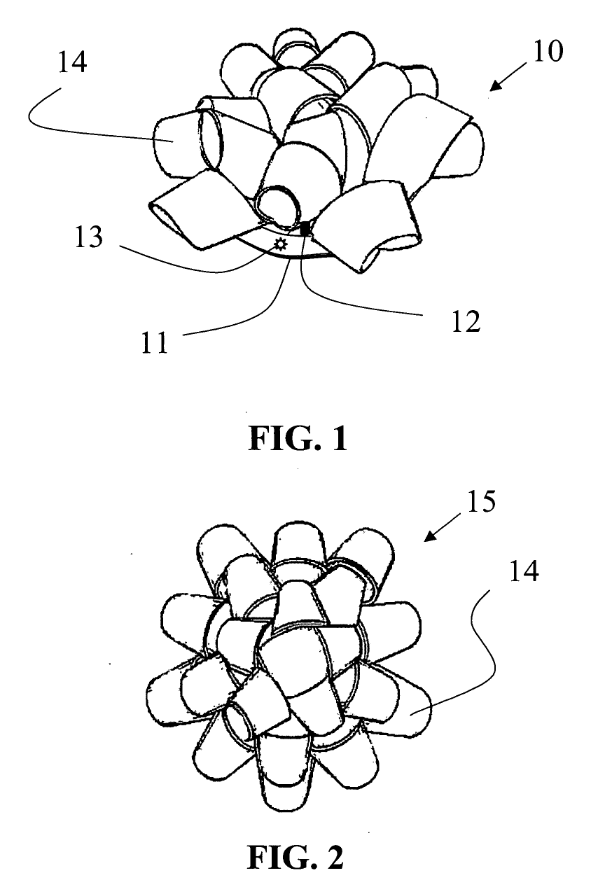

Turning first to FIG. 1 there is shown a perspective view of the embodiment of the invention used for monitoring the safe repose of a gift or package generally as 10 which includes a base member 11 of a shape to receive the electronics assembly that connect to switches 12 and light emitting devices 13 and adorned with an ornamental member 14 decorative bow or the like.

Turning to FIG. 2 there is shown a perspective view of the embodiment of the invention generally as 12 which includes the ornamental member 14 decorative bow.

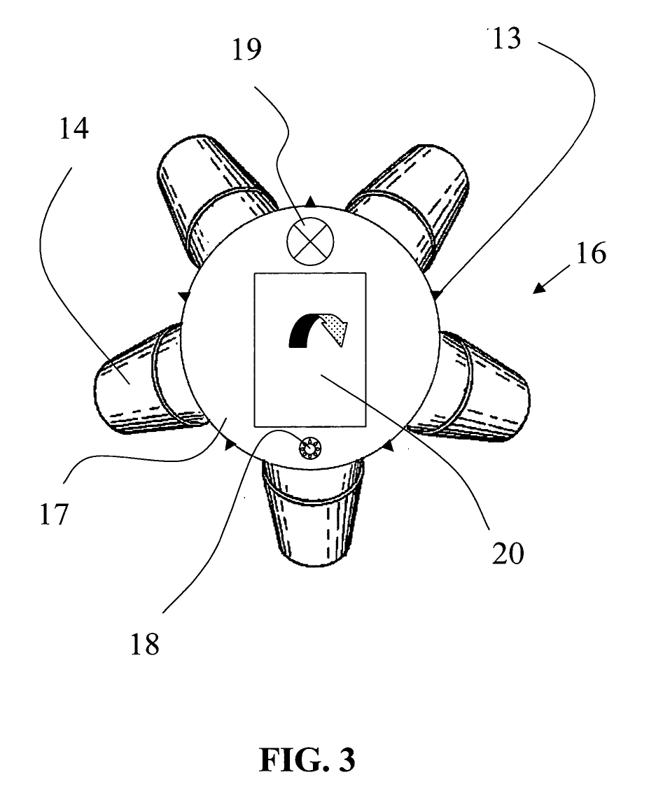

In accordance with the present invention, FIG. 3 shows an with the adhesive strip 20 on base member 17 that houses a microphone 18, a record switch 19 and light emitting devices 13.

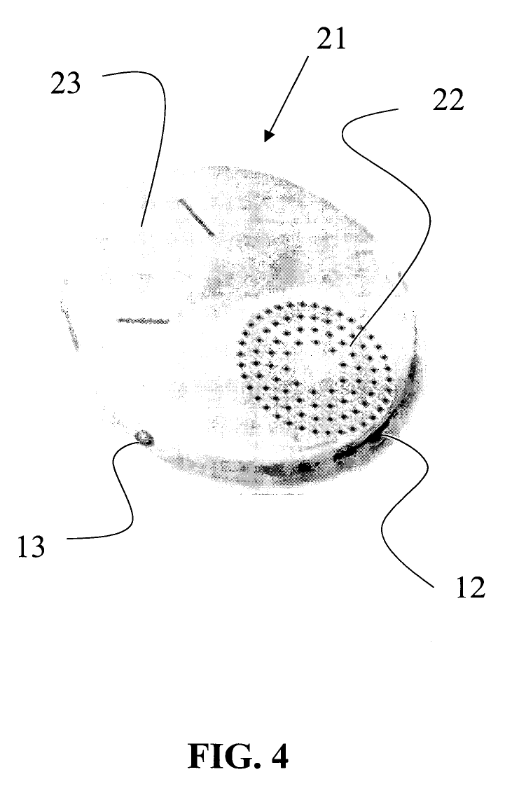

Turning now to FIG. 4 there is shown a perspective view of the embodiment of the invention generally as 21 which includes a speaker 22, a switch 12, light emitting devices 13 and a cover plate 23.

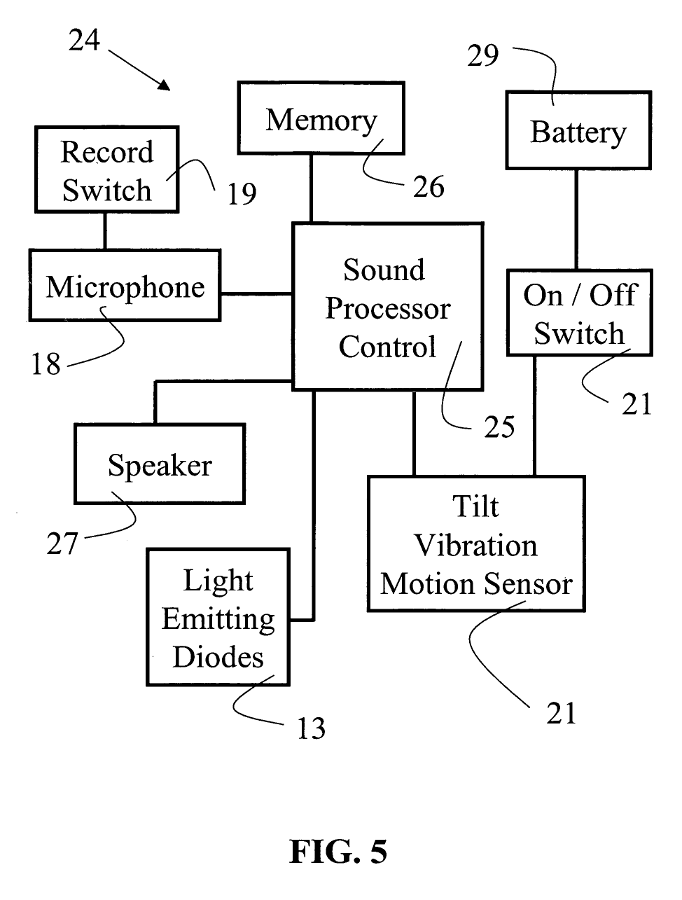

To accomplish an important function of the invention, there is shown in FIG. 5 an electronics assembly diagram generally as 24 that connect to battery 29 through switch 12 monitored by motion sensor 28 that activates sound processor 25 which plays stored file from non-volatile memory 26 that can store recorded input through switch 19 and microphone 18 and output to speaker 27 and (optionally) activates light emitting device 13.

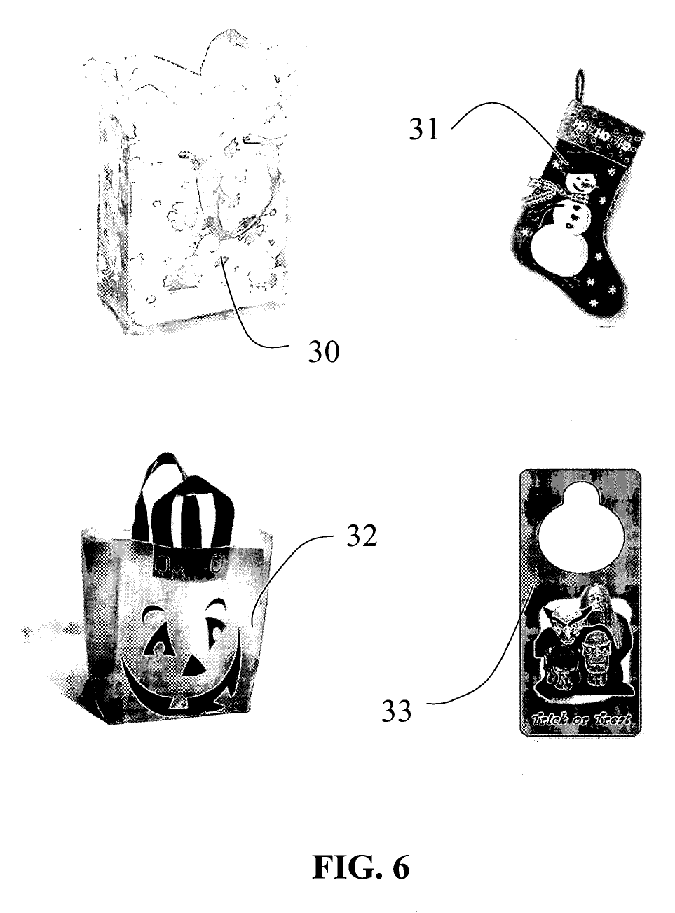

In accordance with an important feature of the present invention, there is shown in FIG. 6, various iterations of ornamental members that incorporate the invention such as a gift bag 30, Christmas stocking 31, Halloween Bag 32 and a door knob hanging tag 33.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An apparatus to monitor the natural at rest status of an item and alerting system whereupon movement of the item is detected when the item is otherwise disturbed from its natural at rest position comprising:
a base member of a shape to receive the electronics assembly;
a circuit board;
a motion sensor;
a sound chip;
a microphone;
a speaker;
switches;
connection means for connecting to a power source;
contains a non-volatile memory means;
a cover plate means secured to said base member and securing said electronics assembly;
adhesive tape; and
an ornamental member attached to said apparatus so as to be exchanged in favor of another ornamental member.

2. An apparatus to monitor the natural at rest status of an item and alerting system whereupon movement of the item is detected when the item is otherwise disturbed from its natural at rest position as claimed in claim 1 wherein said circuit board is connected to said motion sensor which includes the ability to monitor one or more motions including: tilt, vibration, orientation, acceleration.

3. An apparatus to monitor the natural at rest status of an item and alerting system whereupon movement of the item is detected when the item is otherwise disturbed from its natural at rest position as claimed in claim 1 wherein said circuit board is connected to said speaker to facilitate an audio component.

4. An apparatus to monitor the natural at rest status of an item and alerting system whereupon movement of the item is detected when the item is otherwise disturbed from its natural at rest position as claimed in claim 3 wherein said circuit board also contains a non-volatile memory means.

5. An apparatus to monitor the natural at rest status of an item and alerting system whereupon movement of the item is detected when the item is otherwise disturbed from its natural at rest position as claimed in claim 1 wherein said circuit board is connected to said microphone to facilitate an audio recording component.

6. An apparatus to monitor the natural at rest status of an item and alerting system whereupon movement of the item is detected when the item is otherwise disturbed from its natural at rest position as claimed in claim 1 wherein said connection means is adapted to connect to batteries contained in said apparatus.

7. An apparatus to monitor the natural at rest status of an item and alerting system whereupon movement of the item is detected when the item is otherwise disturbed from its natural at rest position as claimed in claim 1 wherein said ornamental member is a decorative bow.

8. An apparatus to monitor the natural at rest status of an item and alerting system whereupon movement of the item is detected when the item is otherwise disturbed from its natural at rest position as claimed in claim 1 wherein said ornamental member is a gift bag.

9. An apparatus to monitor the natural at rest status of an item and alerting system whereupon movement of the item is detected when the item is otherwise disturbed from its natural at rest position as claimed in claim 1 wherein said ornamental member is a door knob hanger.

10. An apparatus to monitor the natural at rest status of an item and alerting system whereupon movement of the item is detected when the item is otherwise disturbed from its natural at rest position as claimed in claim 1 wherein said ornamental member is a Christmas stocking.

11. An apparatus to monitor the natural at rest status of an item and alerting system whereupon movement of the item is detected when the item is otherwise disturbed from its natural at rest position as claimed in claim 1 wherein said ornamental member is a Easter egg basket.

12. An apparatus to monitor the natural at rest status of an item and alerting system whereupon movement of the item is detected when the item is otherwise disturbed from its natural at rest position as claimed in claim 1 wherein said ornamental member is an anchor base for decorative helium balloons.

13. An apparatus to monitor the natural at rest status of an item and alerting system whereupon movement of the item is detected when the item is otherwise disturbed from its natural at rest position as claimed in claim 1 wherein said adhesive tape affixes the apparatus to a gift, package or other item.

14. An apparatus to monitor the natural at rest status of an item and alerting system whereupon movement of the item is detected or the item is otherwise disturbed from its natural at rest position comprising:
a base member of a shape to receive the electronics assembly;
a circuit board;
a motion sensor;
a sound chip;
a microphone;
a speaker;
switches;
connection means for connecting to a power source;
contains a non-volatile memory means;
a cover plate means secured to said base member and securing said electronics assembly;
adhesive tape; and
an ornamental member attached to said apparatus so as to be exchanged in favor of another ornamental member.

15. An apparatus to monitor the natural at rest status of an item and alerting system whereupon movement of the item is detected or the item is otherwise disturbed from its natural at rest position as claimed in claim 14 wherein said circuit board is connected to said light emitting device to facilitate illumination.

16. An apparatus to monitor the natural at rest status of an item and alerting system whereupon movement of the item is detected or the item is otherwise disturbed from its natural at rest position as claimed in claim 14 wherein said motion sensor determines movement exerted in one direction.

17. An apparatus to monitor the natural at rest status of an item and alerting system whereupon movement of the item is detected or the item is otherwise disturbed from its natural at rest position as claimed in claim 14 wherein said ornamental member is a Halloween Trick or Treat bag or vessel.
